(19) United States
(12) Patent Application Publication
(10) Pub. No.: US 2009/0164040 A1
(43) Pub. Date: Jun. 25, 2009

(54) Method of processing semiconductor substrate and processing apparatus

(75) Inventor: Shinji Kawada, Miyagi (JP)

Correspondence Address: KUBOTERA & ASSOCIATES, LLC, Suite 202, 200 Daingerfield Road, Alexandria, VA, 22314, US

(73) Assignee: Oki Semiconductor Co., Ltd

(21) Appl. No.: 12/314,459

(22) Filed: Dec. 11, 2008

(30) Foreign Application Priority Data
Dec. 20, 2007 (JP) 2007-328554

(51) Int. Cl. G06F 19/00

(52) U.S. Cl. 700/121

(57) ABSTRACT

A method of processing semiconductor substrates includes the steps of: storing attribution data indicating an attribution of each of the semiconductor substrates in a recording medium according to piece identification codes of the semiconductor substrates; generating a start direction accompanying one of the piece identification codes of the semiconductor substrates with a control unit; retrieving the attribution data corresponding to one of the semiconductor substrate related to the start direction from the recording medium with a processing condition setting unit; selecting one of processing conditions according to the attribution data thus retrieved and a processing condition determining table in which a plurality of the processing conditions is set according to the attributions of the semiconductor substrates with the processing condition setting unit; and processing one of the semiconductor substrates related to the start direction under the one of the processing conditions thus selected with a processing unit.

### BACKGROUND OF THE INVENTION AND RELATED ART STATEMENT

The present invention relates to a method of processing a semiconductor substrate and a processing apparatus for processing a semiconductor substrate.

In a conventional SOI (Silicon on Insulator) device, a semiconductor substrate layer is electrically separated from a semiconductor forming layer (an SOI layer) with an embedded oxide film. Accordingly, it is possible to easily insulate elements arranged next to each other. Further, a parasite thyristor is not generated in the semiconductor forming layer, thereby making it possible to prevent a latch-up phenomenon.

In the conventional SOI device, when a transistor is formed in the semiconductor forming layer (the SOI layer) on an insulating film, it is possible to suppress a so-called short channel effect, in which power consumption tends to increase as a size of a transistor decreases. Further, when a transistor is formed in the SOI structure, the transistor tends to have a connection capacity smaller than that of a transistor having a bulk structure, thereby making a high speed operation possible.

As described above, when the transistor has the SOI structure, it is possible to provide a device having various advantages such as a high speed operation and low power consumption as opposed to the transistor formed on a bulk substrate.

A wafer having the SOI structure (an SOI substrate) has been used for a UV (Ultraviolet Light) sensor (an SOI UV sensor). When the UV sensor is formed of a semiconductor compound such as gallium nitride, it is difficult to mount a peripheral circuit on one chip. When the UV sensor is formed of a silicon semiconductor compound such as gallium nitride, the UV sensor tends to have sensitivity with respect to light in a wide wavelength range. Accordingly, it is necessary to provide an optical filter for blocking visible light, thereby increasing a cost and lowering sensitivity.

When the UV sensor is formed of the SOI substrate, on the other hand, it is possible to dispose a peripheral circuit such as an operation amplifier on one chip. Further, it is possible to form a photodiode having sensitivity only to UV light through reducing a thickness of the SOI substrate, thereby obtaining good spectroscopic sensitivity without an optical filter.

When the UV sensor is formed of the SOI substrate, a peak wavelength of a detection output depends on a thickness of an SOI layer where a light receiving element is formed. Accordingly, it is necessary to precisely control the thickness of the SOI layer. In an actual case, the SOI substrate is etched before delivery for adjusting the thickness of the SOI layer. Accordingly, it is necessary to precisely control the etching process to minimize a variance in the thicknesses of the SOI layers among the SOI substrates or different lots.

Patent Reference 1 has disclosed a substrate processing apparatus having a unit for setting a thermal processing condition according to a number of wafers to be processed in a thermal processing unit, thereby reducing a variance among the wafers or different lots in a manufacturing process. In the substrate processing apparatus, the thermal processing condition is determined according to a number of the wafers to be processed. Accordingly, it is possible to maintain thermal history of the wafers constant without a dummy wafer.

Patent Reference 2 has disclosed a substrate processing apparatus capable of processing a wafer through an input operation of a text string formed of substrate specific information specifying the wafer and processing content information indicating processing contents of the wafer.

Patent Reference 1: Japanese Patent Publication No. 10-189465

Patent Reference 2: Japanese Patent Publication No. 2000-031242

FIG. 1 is a block diagram showing a conventional substrate processing apparatus. As shown in FIG. 1, the conventional substrate processing apparatus includes a host system 1′ and an etching process, device 2′. The etching process device 2′ includes a substrate transport unit 3′ and an etching process unit 4′.

In the conventional substrate processing apparatus, the host system 1′ specifies a processing condition such as an etching time, and sends a direction to the etching process device 2′. The substrate transport unit 3′ transports a wafer of a subject lot to the etching process unit 4′. The etching process unit 4′ etches a plurality of wafers in the lot according to the processing condition directed from the host system 1′. When all wafers in the lot are completely processed, the etching process unit 4′ sends a result to the host system 1′, thereby completing the process.

In general, the SOI substrates tend to have a variance in the SOI layers in an initial state of delivery. The conventional substrate processing apparatus processes a plurality of SOI substrates under a single processing condition. Accordingly, all the SOI substrates are etched to an identical degree, thereby making it difficult to reduce the variance in the SOI layers thereof.

In a manufacturing process using the conventional substrate processing apparatus, the variance in the SOI layer at the initial state is maintained until a last step of the manufacturing process. Accordingly, when the SOI substrates have a large variance in the SOI layers thereof at the initial state, it is difficult to produce an UV sensor with stable detection sensitivity.

When lots of the SOI substrates are assembled into a lot according to thicknesses of the SOI layers thereof at the initial state, the processing condition of etching is adjusted per lot. Accordingly, it is necessary for an operator to operate the host system 1′ to change the processing condition every time the lot of the semiconductor substrates is changed, thereby making lot management and condition adjustment complicated, and causing a human error.

In view of the problems described above, an object of the present invention is to provide a method of processing a semiconductor substrate, and a processing apparatus for processing a semiconductor substrate. In the method of the present invention, it is possible to automatically set a processing condition every time the semiconductor substrate or a lot of the semiconductor substrates is changed.

Further objects and advantages of the invention will be apparent from the following description of the invention.

### SUMMARY OF THE INVENTION

In order to attain the objects described above, according to a first aspect of the present invention, a method of processing a plurality of semiconductor substrates sequentially supplied thereto includes the steps of: storing attribution data indicating an attribution of each of the semiconductor substrates in a recording medium according to piece identification codes of the semiconductor substrates; generating a start direction accompanying one of the piece identification codes of the semiconductor substrates with a control unit; retrieving the attribution data corresponding to one of the semiconductor substrate related to the start direction from the recording medium with a processing condition setting unit; selecting one of processing conditions according to the attribution data thus retrieved and a processing condition determining table in which a plurality of the processing conditions is set according to the attributions of the semiconductor substrates with the processing condition setting unit; and processing one of the semiconductor substrates related to the start direction under the one of the processing conditions thus selected with a processing unit.

According to a second aspect of the present invention, a processing apparatus for processing a plurality of semiconductor substrates sequentially supplied thereto includes an attribution data storage unit for storing attribution data indicating an attribution of each of the semiconductor substrates in a recording medium; a processing condition determining table for storing a plurality of processing conditions according to the attributions of the semiconductor substrates; a control unit for generating a start direction accompanying a piece identification code of one of the semiconductor substrates; a processing condition setting unit for retrieving the attribution data corresponding to the one of the semiconductor substrate related to the start direction from the recording medium, and for selecting one of the processing conditions according to the attribution data thus retrieved and the processing condition determining table; and a processing unit for processing the one of the semiconductor substrates under the one of the processing conditions thus selected.

In the method of processing the semiconductor substrate and the processing apparatus of the present invention, it is possible to automatically set the processing condition suitable for the semiconductor substrate of a lot of the semiconductor substrates. Accordingly, it is possible to stably produce a device with a uniform structure.

### BRIEF DESCRIPTION OF THE DRAWINGS

FIG. 1 is a block diagram showing a conventional processing apparatus for processing a semiconductor substrate;

FIG. 2 is a block diagram showing a processing apparatus for processing a semiconductor substrate according to an embodiment of the present invention;

FIG. 3 is a table showing an example of data stored in a data storage unit of the processing apparatus according to the embodiment of the present invention;

FIG. 4 is a table showing an example of a processing condition determining table of the processing apparatus according to the embodiment of the present invention;

FIG. 5 is a schematic view showing an etching process unit of the processing apparatus according to the embodiment of the present invention;

FIG. 6 is a table showing an example of a recipe table of the processing apparatus according to the embodiment of the present invention;

FIG. 7 is a flow chart showing an operation of the processing apparatus according to the embodiment of the present invention;

FIGS. 8(a) and 8(b) are schematic sectional views showing a semiconductor substrate, wherein FIG. 8(a) is a schematic sectional view showing the semiconductor substrate before processed with the processing apparatus, and FIG. 8(b) is a schematic sectional view showing the semiconductor substrate after processed with the processing apparatus;

FIG. 9 is a flow chart showing a method of producing an SOI-UV sensor using the processing apparatus according to the embodiment of the present invention;

FIG. 10(a) is a table showing an example of thickness data of the semiconductor substrates stored in a data storage unit of the processing apparatus according to the embodiment of the present invention; and

FIG. 10(b) is a table showing an example of a lot arrangement result of a substrate grouping device of the processing apparatus according to the embodiment of the present invention.

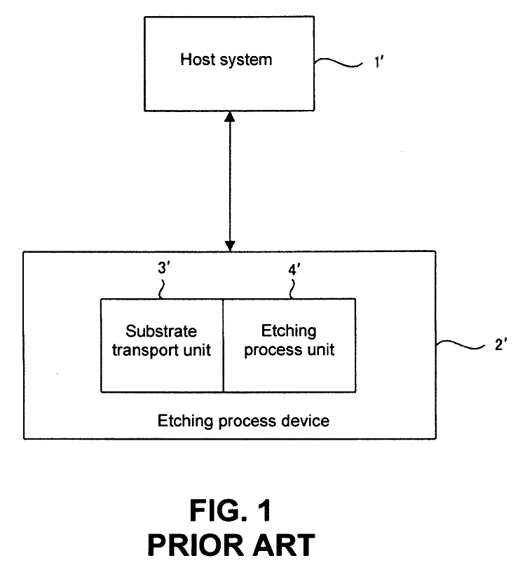

### DETAILED DESCRIPTION OF PREFERRED EMBODIMENTS

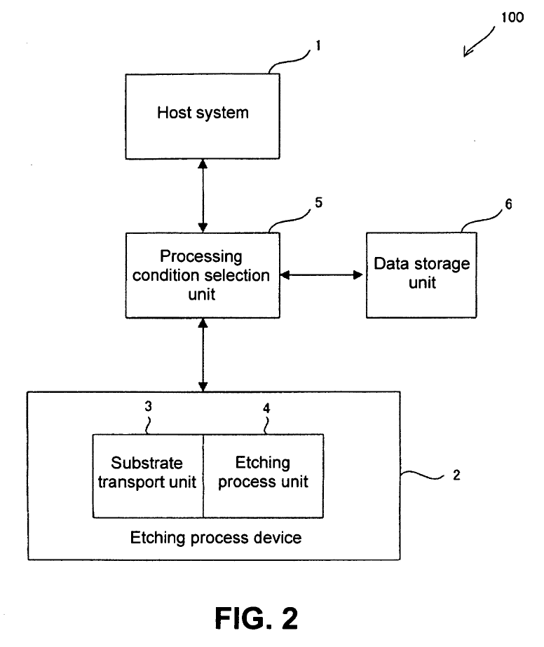

Hereunder, preferred embodiments of the present invention will be explained with reference to the accompanying drawings. In the following description, substantially similar components or equivalent components are designated with the same reference numerals. FIG. 2 is a block diagram showing a processing apparatus 100 for processing a semiconductor substrate according to an embodiment of the present invention.

As shown in FIG. 2, the processing apparatus 100 includes a host system 1; an etching process device 2; a processing condition selection unit 5; and a data storage unit 6. The processing condition selection unit 5 is connected for communication to the host system 1, the etching process device 2, and the data storage unit 6. The processing apparatus 100 is configured for processing semiconductor substrates of one single type (one single grade).

In the embodiment, the host system 1 is a main control unit for controlling the processing apparatus 100 as a whole. The host system 1 sends an execution direction to the processing condition selection unit 5. The execution direction includes a lot ID or an identification code of a lot to be processed and a recipe ID indicating a processing content as additional information. Further, the host system 1 receives a report of a processing status through the processing condition selection unit 5.

In the embodiment, the data storage unit 6 is a recording medium storing attribution data indicating an attribution of an SOI (Silicon on Insulator) substrate. The attribution of the SOI substrate is measured with various measurement devices in a previous step. For example, in the previous step, a thickness of an SOI layer of each of the SOI substrates is stored in the data storage unit 6 as the attribution data in such a way that the attribution data correspond to piece identification codes for specifying the SOI substrates.

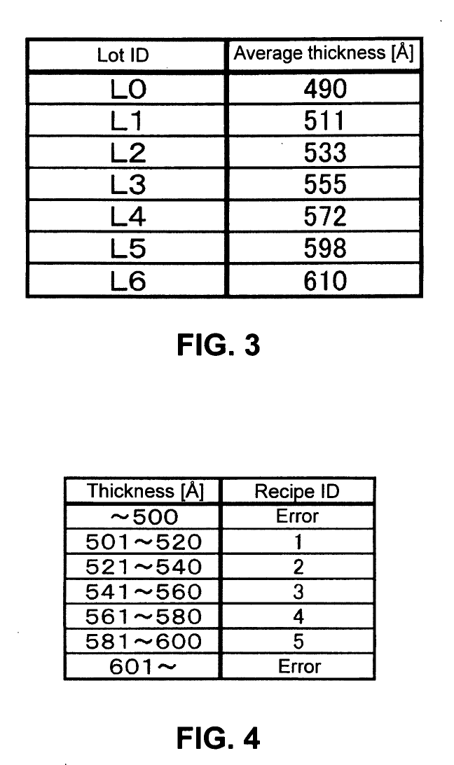

FIG. 3 is a table showing an example of the data stored in the data storage unit 6 of the processing apparatus 100 according to the embodiment of the present invention. The SOI substrates having similar thicknesses of the SOI layers thereof are arranged in one lot with a substrate grouping device (not shown), thereby assembling lots. Upon assembling the lots, the lot ID is assigned to each lot. As shown in FIG. 3, average data of initial thicknesses of the SOI layers per lot thus assembled are stored in the data storage unit 6 in such a way that the average data correspond to the lot IDs specifying the lots.

In the embodiment, the thickness of the SOI layer is determined with an optical method in a non-destructive manner. The thickness measurement, the lot assembly, and the data storage to the data storage unit 6 are performed automatically. Further, in addition to the initial thicknesses of the SOI layers, the data storage unit 6 stores various data measured in a step of a manufacturing process in such a way that the data correspond to the lot IDs.

In the embodiment, the processing condition selection unit 5 determines an etching condition of the etching process device 2 according to the initial thickness of the SOI substrate to be processed.

FIG. 4 is a table showing an example of a processing condition determining table of the processing apparatus 100 according to the embodiment of the present invention. As shown in FIG. 4, the processing condition selection unit 5 includes the processing condition determining table, in which a recipe ID corresponds to a range of the thickness of the SOI layer. The recipe ID is an identification code specifying the etching condition of the etching process device 2.

In the embodiment, the processing condition selection unit 5 retrieves the average data of the initial thicknesses of the SOI layers within a lot corresponding to the lot to be processed from the data storage unit 6 with the lot ID sent from the host system 1 as a key. Then, the processing condition selection unit 5 selects the recipe ID corresponding to the average data with reference to the processing condition determining table. More specifically, the processing condition selection unit 5 select one of a plurality of processing conditions according to the average thickness of the lot to be processed according to the attribute of the SOI substrate stored in advance.

In the processing condition determining table shown in FIG. 4, when the processing condition selection unit 5 retrieves the average data of the initial thicknesses of the SOI layers in the lot to be processes in the range of 501 to 520 Å, for example, the processing condition selection unit 5 selects the recipe ID “1”. When the processing condition selection unit 5 retrieves the average data of the initial thicknesses in the range of 521 to 540 Å, the processing condition selection unit 5 selects the recipe ID “2”. When the processing condition selection unit 5 retrieves the average data of the initial thicknesses in the range of 541 to 560 Å, the processing condition selection unit 5 selects the recipe ID “3”. When the processing condition selection unit 5 retrieves the average data of the initial thicknesses in the range of 561 to 580 Å, the processing condition selection unit 5 selects the recipe ID “4”. When the processing condition selection unit 5 retrieves the average data of the initial thicknesses in the range of 581 to 600 Å, the processing condition selection unit 5 selects the recipe ID “5”.

In the next step, the processing condition selection unit 5 sends the recipe ID thus selected to the etching process device 2. When the processing condition selection unit 5 retrieves the average data of the initial thicknesses less than 500 Å or greater than 600 521 , the processing condition selection unit 5 sends an error signal to the host system 1 indicating that the average data of the initial thicknesses exceeds a control limit. When the host system 1 receives the error signal, the host system 1 displays a notice indicating that there is an SOI substrate exceeding the control limit on a display screen connected to the host system 1. In the processing condition determining table shown in FIG. 4, it is possible to adjust the thickness range of the SOI layer, and the correlation between the thickness range and the recipe ID.

In the embodiment, the etching process device 2 includes a substrate transport unit 3 and an etching process unit 4. As described above, the SOI substrates are assembled in the lots according to the initial thicknesses of the SOI layers thereof, and are set in the substrate transport unit 3 in a state of being stored in a storage member per lot.

In the embodiment, the substrate transport unit 3 identifies the lot to be processes according to the lot ID sent from the processing condition selection unit 5, and takes out the SOI substrates belonging to the lot thus identified, thereby transporting the SOI substrates to the etching process unit 4. When the etching process unit 4 completes the etching process, the substrate transport unit 3 takes out the SOI substrates from the etching process unit 4 and stores the SOI substrates in the storage member. Afterward, the substrate transport unit 3 transports the SOI substrates unprocessed to the etching process unit 4, thereby repeating the steps described above.

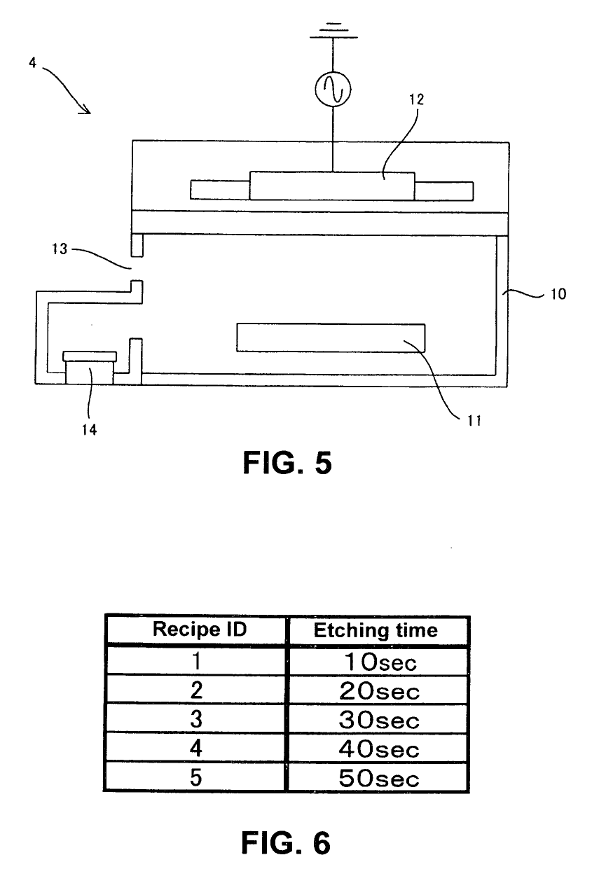

FIG. 5 is a schematic view showing the etching process unit 4 of the processing apparatus 100 according to the embodiment of the present invention. As shown in FIG. 5, the etching process unit 4 includes a processing chamber 10; a lower electrode 11 disposed in the processing chamber 10; an upper electrode 12 arranged to face the lower electrode 11; a gas inlet 13; and an exhaust outlet 14, thereby constituting a plasma etching apparatus of a parallel plate type.

In the etching process unit 4, an etching gas is introduced from the gas inlet 13 and is exhausted from the exhaust outlet 14 to maintain a pressure inside the processing chamber 10 at a constant level. In this state, specific high frequency power is applied to the upper electrode 12 to generate plasma discharge, thereby etching the SOI substrate placed on the lower electrode 11.

FIG. 6 is a table showing an example of a recipe table of the processing apparatus 100 according to the embodiment of the present invention. In the embodiment, the etching process unit 4 sets the etching condition according to the recipe ID received from the processing condition selection unit 5. More specifically, the etching process unit 4 stores a plurality of etching time settings as the etching conditions in advance, that is, the etching process unit 4 stores the recipe table shown in FIG. 6, in which the etching time settings are correlated to the recipe IDs. Accordingly, the etching process unit 4 sets the etching time with reference to the recipe table according to the recipe ID sent from the processing condition selection unit 5, so that the etching process unit 4 applies the etching process to the SOI substrate to be processed at the etching time thus set.

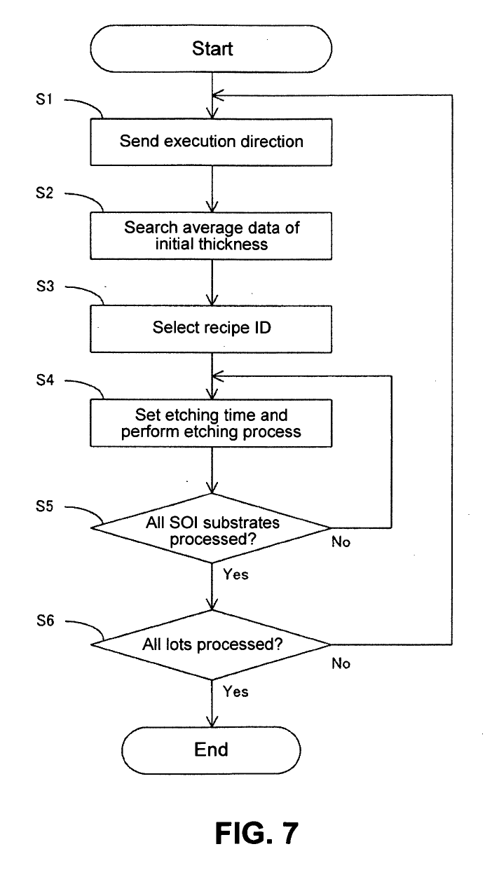

An operation of the processing apparatus 100 will be explained next with reference to FIG. 7. FIG. 7 is a flow chart showing the operation of the processing apparatus 100 according to the embodiment of the present invention. A program is stored in the host system 1 for executing the operation shown in the flow chart.

In the following description, is it assumed that the SOI substrates are already assembled in the lots according to the initial thicknesses of the SOI layers thereof, and the average data of the initial thicknesses of the SOI layers within a lot are stored in the data storage unit 6 while corresponding to the lot IDs. Further, it is assumed that the recipe IDs are set in the processing condition determining table according to the range of the initial thicknesses of the SOI layers.

In step S1, the host system 1 sends the execution direction including the lot ID corresponding to the lot to be processed and the recipe ID indicating the processing content as the additional information to the processing condition selection unit 5.

In step S2, when the processing condition selection unit 5 receives the execution direction, the processing condition selection unit 5 accesses to the data storage unit 6 for searching the average data of the initial thicknesses of the SOI layers within a lot corresponding to the lot to be processed with the lot ID and the recipe ID as a key. As described above, the average data of the initial thicknesses of the SOI layers within a lot are stored in the data storage unit 6.

As described above, the data storage unit 6 stores the various data measured corresponding to each of the lots after the assembly thereof. Accordingly, it is possible to identify the lot with the lot ID, and identify a type of data with the recipe ID. When the processing condition selection unit 5 detects the average data corresponding to the lot to be processed, the processing condition selection unit 5 retrieves the average data from the data storage unit 6.

In step S3, the processing condition selection unit 5 selects the recipe ID corresponding to the average data thus retrieved in step S2 with reference to the processing condition determining table shown in FIG. 4. For example, when the processing condition selection unit 5 retrieves the average data of the initial thicknesses of the SOI layers within a lot of 530 Å from the data storage unit 6, the processing condition selection unit 5 selects the recipe ID “2”.

In the next step, the processing condition selection unit 5 converts the recipe ID received from the host system 1 to the recipe ID thus selected according to the initial thicknesses of the SOI layers. Then, the processing condition selection unit 5 sends the recipe ID thus selected and the lot ID received from the host system 1 to the etching process device 2.

As described above, the SOI substrates are assembled in the lots according to the initial thicknesses of the SOI layers thereof, and are set in the substrate transport unit 3 of the etching process device 2 in the state of being stored in the storage member per lot. That is, the SOI substrates having similar thicknesses of the SOI layers thereof are arranged in a same lot, and are set in the substrate transport unit 3 in the state of being stored in a same storage member.

In the next step, the substrate transport unit 3 identifies the lot to be processed according to the lot ID received from the processing condition selection unit 5. Then, the substrate transport unit 3 takes out a specific number of the SOI substrates corresponding to the lot thus identified, thereby transporting the SOI substrates to the processing chamber of the etching process unit 4.

In step S4, the etching process unit 4 sets the etching time with reference to the recipe table shown in FIG. 6 according to the recipe ID received from the processing condition selection unit 5. According to the example shown in FIG. 6, when the recipe ID “2” is received from the processing condition selection unit 5, the etching process unit 4 sets the etching time at 20 seconds. Accordingly, the etching process unit 4 irradiates plasma to the SOI substrates thus delivered for 20 seconds, thereby etching the SOI layers thereof.

When the etching process unit 4 completes the etching process, the substrate transport unit 3 collects the SOI substrates from the processing chamber of the etching process unit 4, and transports the SOI substrates unprocessed to the etching process unit 4. When the SOI substrates transported in the etching process unit 4 belong to the same lot, the etching process unit 4 applies the etching process to the SOI substrates under the same etching condition. A series of the steps described above is repeated until all the SOI substrates in the same lot are processed. The etching process unit 4 sends a processing status to the host system 1 through the processing condition 4election unit 5.

In step S5, the host system 1 determines whether all the SOI substrates in the same lot are processed according to the processing status sent from the etching process unit 4.

In step S6, when the host system 1 determines that all the SOI substrates in the same lot are processed, the host system 1 determines whether all the lots to be processed are processed. When the host system 1 determines that all the lots are not processed, the process returns to step S1. Accordingly, the host system 1 sends the execution direction including a new lot ID and a new recipe ID as the additional information to the processing condition selection unit 5, thereby starting the etching process for the new lot. Then, the process from step S2 to step S5 is repeated for applying the etching process to the new lot according to an etching time corresponding to the average data of the initial thicknesses of the new lot.

When the host system 1 determines that all the lots are processed in step S6, the process is completed.

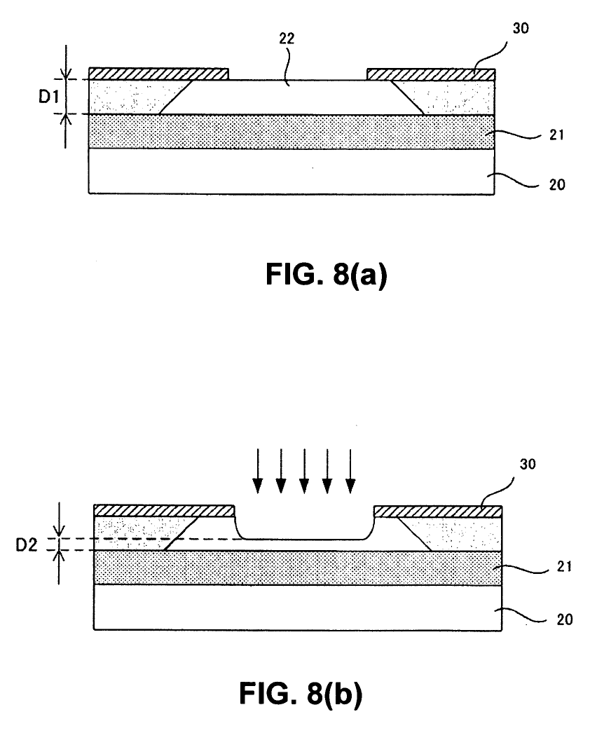

A configuration of the SOI substrate processed with the processing apparatus 100 described above will be explained next in more detail. FIGS. 8(a) and 8(b) are schematic sectional views showing the SOI substrate. More specifically, FIG. 8(a) is a schematic sectional view showing the SOI substrate before the etching process performed with the etching process device 2, and FIG. 8(b) is a schematic sectional view showing the semiconductor substrate after the etching process.

As shown in FIGS. 8(a) and 8(b), the SOI substrate has an SOI structure formed of a semiconductor layer 20; an insulating layer (BOX layer) 21; an SOI layer 22. Further, an NSG layer 30 with an opening portion is formed on the SOI layer 22.

In the embodiment, the NSG layer 30 functions as a mask during the etching process of the SOI layer 22. More specifically, a portion of the SOI layer 22 exposed from the opening portion of the NSG layer 30 is etched in the etching process.

As described above, an initial thickness D1 of the SOI layer 22 is measured before the etching process, and the SOI substrates are assembled into the lot according to the initial thicknesses D1 of the SOI layers 22. Then, the average data of the initial thicknesses D1 of the SOI layers 22 within the lot are stored in the data storage unit 6 in such a way that the average data correspond to the lot ID. Afterward, the processing condition selection unit 5 selects the recipe ID according to the average data stored in the data storage unit 6, and the etching process unit 4 performs the etching process according to the etching time indicated by the recipe ID.

As shown in FIG. 8(b), after the etching process, the SOI layer 22 has a thickness D2. In the method of the embodiment, the etching time is adjusted such that the processing time becomes longer when the initial thicknesses D1 of the SOI layers 22 are relatively large, and the processing time becomes shorter when the initial thicknesses D1 of the SOI layers 22 are relatively small.

In the embodiment, as described above, the processing condition selection unit 5 selects the recipe ID according to the initial thicknesses D1 with reference to the processing condition determining table. Further, the processing apparatus 100 automatically adjust the etching time per lot, thereby making it unnecessary to assign an operation, and making it possible to eliminate a human error.

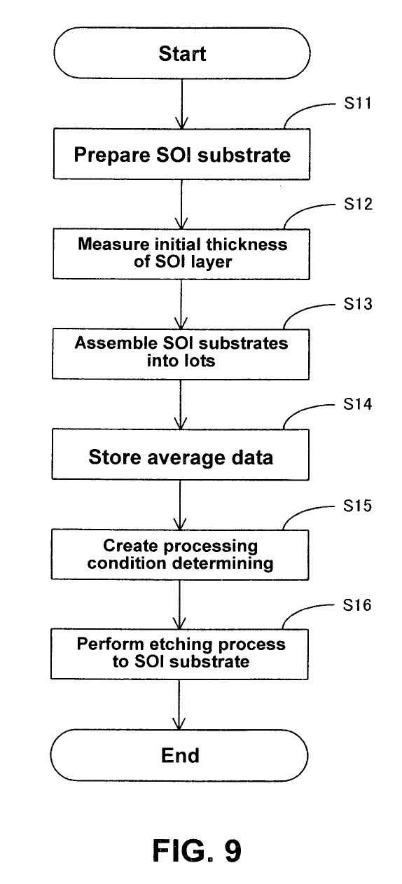

A method of producing an SOI UV sensor will be explained with reference to FIG. 9. The method includes the etching process performed with the processing apparatus 100. FIG. 9 is a flow chart showing the method of producing the SOI UV sensor using the processing apparatus 100 according to the embodiment of the present invention.

In step S11, the SOI substrate is prepared. In step S2, the initial thickness of the SOI layer is determined with a film thickness measurement device of a non-destructive type using an optical method. The film thickness measurement device measures the initial thicknesses of the SOI layers of all SOI substrates to be processed.

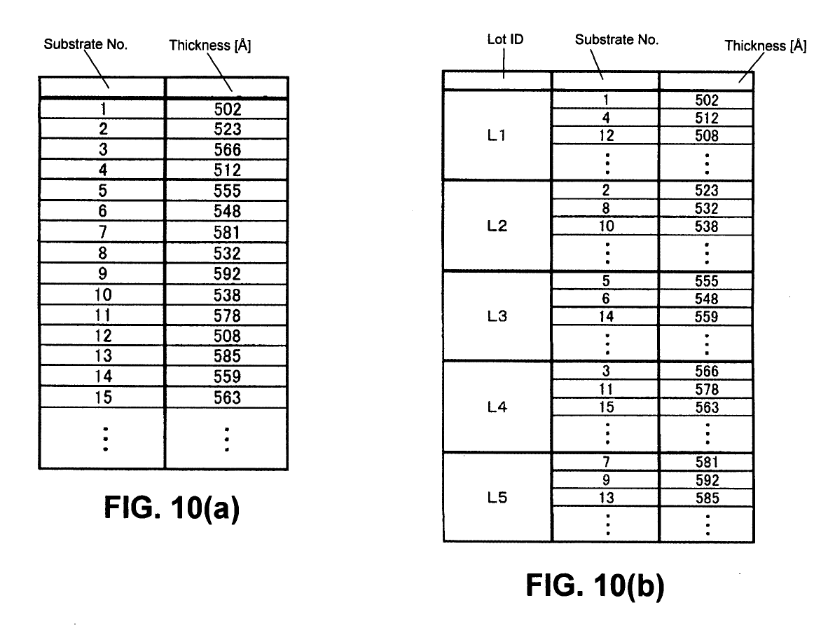

FIG. 10(a) is a table showing an example of thickness data of the semiconductor substrates stored in the data storage unit 6 of the processing apparatus 100 according to the embodiment of the present invention. After the thickness measurement, the thickness data is stored in the data storage unit 6 in such a way that the thickness data correspond to the identification codes specifying each of the SOI substrates.

In step S13, the SOI substrates are assembled into the lot according to the thickness data of the SOI substrates stored in the data storage unit 6, so that the SOI substrates having similar initial thicknesses of the SOI layers belong to a same lot.

FIG. 10(b) is a table showing an example of a lot arrangement result of the substrate grouping device (not shown) of the processing apparatus 100 according to the embodiment of the present invention. As shown in FIG. 10(b), the substrate grouping device assembles a first lot in which the SOI substrates includes the SOI layers having the initial thicknesses of 501 to 520 Å; a second lot in which the SOI substrates includes the SOI layers having the initial thicknesses of 521 to 540 Å; a third lot in which the SOI substrates includes the SOI layers having the initial thicknesses of 541 to 560 Å; a fourth lot in which the SOI substrates includes the SOI layers having the initial thicknesses of 561 to 580 Å; and a fifth lot in which the SOI substrates includes the SOI layers having the initial thicknesses of 581 to 600 Å.

After the substrate grouping device assembles the first lot to the fifth lot, the processing apparatus 100 stores the SOI substrates in the same lot into a same storage member, thereby grouping the SOI substrates.

In step S14, the processing apparatus 100 determines the average data of the initial thicknesses of the SOI layers within lot, and stores the average data in the data storage unit 6 in such a way that the average data correspond to the lot ID. As described above, it is possible to adjust the range of the initial thicknesses for assembling the lots.

In step S15, the processing condition determining table is created and stored for setting the processing condition according to the initial thicknesses of the SOI layers.

As described above, the initial thicknesses of the SOI layers are grouped into the ranges for setting the processing condition. Then, the recipe IDs are assigned to the ranges to create the processing condition determining table shown in FIG. 4. It may not be necessary to frequently update the processing condition determining table. IN this case, it is possible to omit step S15.

In step S16, the processing apparatus 100 performs the etching process to the SOI substrate to adjust the thicknesses of the SOI layers. More specifically, after step S15, the SOI substrates are stored in the storage member per lot. Then, the SOI substrates are set in the substrate transport unit 3 of the etching process device 2, thereby performing the etching process according to the process shown in FIG. 7.

As described above, the average data of the initial thicknesses of the lot to be processed are stored in step S14, and are retrieved in step S16, so that the processing condition is selected according to the average data thus retrieved. When the processing condition is selected, the processing condition determining table created in step S15 is referred. According to the processing condition thus selected, the etching process device 2 performs the etching process to the SOI substrates of the lot, thereby obtaining the SOI UV sensor.

When the method of processing the semiconductor substrate is introduced to the method of producing the SOI UV sensor, even when the SOI layers have various initial thicknesses, the etching process is performed according to the initial thickness. Accordingly, it is possible to obtain the SOI UV sensor with a uniform thickness of the SOI layer after the etching process. As a result, it is possible to stably produce the SOI UV sensor having a desirable spectroscopic sensitivity.

In the embodiment, the thickness data of the SOI layers determined in the previous step are stored in the recording medium. Then, the thickness data are retrieved from the recording medium, and the etching time is automatically selected according to the thickness data thus retrieved, thereby making it unnecessary to assign an operation, and making it possible to eliminate a human error.

In the embodiment, the lots are assembled according to the initial thicknesses of the SOI layers, and the processing condition is set according to each lot. Alternatively, the processing condition may be set according to each SOI substrate.

In this case, an actual thickness of the SOI layer of each of the SOI substrates is stored in the data storage unit 6 in such a way that the actual thickness corresponds to a piece identification code assigned to the SOI substrate. Then, the processing condition selection unit 5 retrieved actual thickness data corresponding to the SOI substrate to be processed from the data storage unit 6, and selects the processing condition according to the actual thickness data with reference to the processing condition determining table. At last, the etching process device 2 performs the etching process to the SOI substrate to be processed under the processing condition thus selected.

In the embodiment, the etching process device 2 includes the plasma etching apparatus, and may include a wet etching apparatus. In this case, the wet etching apparatus performs a wet etching process for an immersion time corresponding to the recipe ID sent from the processing condition selection unit 5.

In the embodiment, the processing apparatus 100 performs the etching process, and is not limited to the etching process. For example, the processing apparatus 100 may perform a thermal process, a filming process, a flattening process, an impurity implantation process, and the likes.

The disclosure of Japanese Patent Application No. 2007-328554, filed on Dec. 20, 2007, is incorporated in the application by reference.

While the invention has been explained with reference to the specific embodiments of the invention, the explanation is illustrative and the invention is limited only by the appended claims.

What is claimed is:

1. A method of processing a plurality of semiconductor substrates sequentially supplied thereto, comprising the steps of:
storing attribution data indicating an attribution of each of the semiconductor substrates in a recording medium according to piece identification codes of the semiconductor substrates;
generating a start direction accompanying one of the piece identification codes of the semiconductor substrates with a control unit;
retrieving the attribution data corresponding to one of the semiconductor substrate related to the start direction from the recording medium with a processing condition setting unit;
selecting one of processing conditions according to the attribution data and a processing condition determining table in which the processing conditions are set according to the attributions of the semiconductor substrates with the processing condition setting unit; and
processing the one of the semiconductor substrates under the one of the processing conditions with a processing unit.

2. A method of processing a plurality of semiconductor substrates sequentially supplied thereto, comprising the steps of:
assembling the semiconductor substrates into a plurality of lots according to an attribution of each of the semiconductor substrates;
storing attribution data indicating an attribution of each of the semiconductor substrates in a recording medium according to an identification code of each of the lots;
generating a start direction accompanying the identification code of the lot with a control unit;
retrieving the attribution data corresponding to one of the lots related to the start direction from the recording medium with a processing condition setting unit;
selecting one of processing conditions according to the attribution data and a processing condition determining table in which the processing conditions are set according to the attributions of the semiconductor substrates with the processing condition setting unit; and
processing the semiconductor substrates of the lot under the one of the processing conditions with a processing unit.

3. The method of processing the semiconductor substrates according to claim 1, wherein, in the step of storing the attribution data, said semiconductor substrates are formed of SOI (Silicon on Insulator) substrates including SOI layers, said attribution being a thickness of the SOI layer of each of the SOI substrates.

4. The method of processing the semiconductor substrates according to claim 2, wherein, in the step of assembling the semiconductor substrates, said semiconductor substrates are formed of SOI (Silicon on Insulator) substrates including SOI layers, said attribution being a thickness of the SOI layer of each of the SOI substrates.

5. The method of processing the semiconductor substrates according to claim 1, wherein, in the step of processing the semiconductor substrates, said semiconductor substrates are etched, said one of the processing conditions being an etching time.

6. The method of processing the semiconductor substrates according to claim 2, wherein, in the step of processing the semiconductor substrates, said semiconductor substrates are etched, said one of the processing conditions being an etching time.

7. The method of processing the semiconductor substrates according to claim 1, further comprising the step of sending an error signal indicating that the attribution data are not within a specific range.

8. The method of processing the semiconductor substrates according to claim 2, further comprising the step of sending an error signal indicating that the attribution data are not within a specific range.

9. The method of processing the semiconductor substrates according to claim 7, further comprising the step of displaying the error message on a display screen.

10. The method of processing the semiconductor substrates according to claim 8, further comprising the step of displaying the error message on a display screen.

11. A processing apparatus for processing a plurality of semiconductor substrates sequentially supplied thereto, comprising:
an attribution data storage unit for storing attribution data indicating an attribution of each of the semiconductor substrates in a recording medium;
a processing condition determining table for storing a plurality of processing conditions according to the attributions;
a control unit for generating a start direction accompanying a piece identification code of one of the semiconductor substrates;
a processing condition setting unit for retrieving the attribution data corresponding to the one of the semiconductor substrate, and for selecting one of the processing conditions according to the attribution data and the processing condition determining table; and
a processing unit for processing the one of the semiconductor substrates under the one of the processing conditions.

12. The processing apparatus according to claim 11, wherein said processing condition setting unit is adopted to send an error signal when the attribution data are not within a specific range.

13. The processing apparatus according to claim 12, wherein said processing condition setting unit is adopted to display the error signal on a display screen.

14. The processing apparatus according to claim 12, wherein said processing condition determining table includes the specific range so that the processing condition setting unit determines whether the attribution data are within the specific range.

15. The processing apparatus according to claim 11, wherein said processing unit is adopted to perform an etching process on the semiconductor substrates.

16. The processing apparatus according to claim 11, wherein said attribution data storage unit is adopted to store the attribution data indicating thicknesses of SOI layers of the semiconductor substrates.

17. The processing apparatus according to claim 11, wherein said processing condition setting unit is adopted to select an etching time as the one of the processing conditions.
